(19) United States
(12) Patent Application Publication
(10) Pub. No.: US 2014/0062930 A1
(43) Pub. Date: Mar. 6, 2014

(54) TOUCH CONTROL SYSTEM AND CONTROL METHOD THEREOF

(71) Applicant: MStar Semiconductor, Inc., Hsinchu Hsien (TW)

(72) Inventor: Hung-Chi Huang, Zhubei City (TW)

(73) Assignee: MStar Semiconductor, Inc., Hsinchu Hsien (TW)

(21) Appl. No.: 14/016,394

(22) Filed: Sep. 3, 2013

(30) Foreign Application Priority Data
Sep. 6, 2012 (TW) 101132449

(51) Int. Cl. G06F 3/041

(52) U.S. Cl. CPC G06F 3/0414
USPC 345/173

(57) ABSTRACT

A touch control system includes a touch sensing panel, a display device, a switch element and a controller. When the switch element is in a first state, the controller generates position information corresponding to a touch point when the touch sensing panel is touched, and provides the touch position information to a user. Once the switch element is switched from the first state to a second state, the controller performs a target procedure corresponding to a last touch point on the touch sensing panel. The controller does not perform the target procedure when the switch element is in the first state.

This application claims the benefit of Taiwan application Serial No. 101132449, filed Sep. 6, 2012, the subject matter of which is incorporated herein by reference.

### BACKGROUND OF THE INVENTION

1. Field of the Invention

The invention relates in general to a touch control system, and more particularly, to a technique for assisting in generating an accurate touch control response.

2. Description of the Related Art

User interfaces of recent electronic products have become more and more user-friendly and intuitive as technology advances. For example, via a touch screen, a user can directly operate programs as well as input messages/texts/patterns with fingers or a stylus; in this way, it is much easier to convey commands compared to using traditional input devices such as a keyboard or buttons. In practice, a touch screen usually comprises a touch sensing panel and a display device disposed at the back of the touch sensing panel. According to a position of a touch on the touch sensing panel and a currently displayed image on the display device, an electronic device determines an intention of the touch to execute corresponding operations.

For example, in shooting games, directions or targets towards which ammunition is fired may be determined according to a position of a user touch, or a touch control camera may set a position of a user touch as a focal point.

In current touch control mechanisms, a corresponding response procedure is usually performed upon sensing a user touch. However, a user finger itself or a body of a stylus may partly shield a viewing range of the user to hinder the user from accurately touching a desired touch point, such that an electronic device may generate a response different from the user's expectation, e.g., a game point loss or a focusing error.

From the perspective of game applications, due to a size limitation of a touch panel, the above issue cannot be solved even if a screen image of a handheld touch control device is projected to a display system having a larger size. Further, when projecting the screen image to a large-size display system, instead of focusing on the handheld touch control device, the user may be distracted by the display system. Consequently, the intention to accurately touch a target position is even more challenging.

### SUMMARY OF THE INVENTION

The invention is directed to a touch control system and a control method thereof for solving the above issues. Before a user touches an intended target position, an option of re-selecting a touch point is offered through manipulating a switch element. In other words, with the touch control system and the control method thereof, a user is offered greater flexibility such that a corresponding subsequent procedure is only allowed to take place after accurately hitting an intended target position.

According to an embodiment of the present invention, a touch control system is provided. The touch control system comprises a touch sensing panel, a display device, a switch element and a controller. The switch element switches between a first state and a second state. When the switch element is in the first state, the controller generates position information corresponding to a touch point each time the touch sensing panel is touched, and controls the display device to provide the position information of the touch point to a user. Once the switch element is switched from the first state to the second state, the controller performs a target procedure corresponding to a last touch point on the touch sensing panel. When the switch element is in the first state, the controller does not perform the target procedure.

According to another embodiment of the present invention, a control method for a touch control system is provided. The touch control system comprises a touch sensing panel, a display device, a switch element and a controller. The switch element switches in a first state and a second state. The control method comprises the following steps. It is determined whether the switch element is in the first state or the second state. When the switch element is in the first state, position information corresponding to a touch point each time the touch sensing panel is touched is generated, the position information corresponding the touch point is provided to a user. Once the switch element is switched from the first state to the second state, a target procedure corresponding to a last touch point on the touch sensing panel is performed. When the switch element is in the first state, the controller does not perform the target procedure.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 a block diagram of a touch control system according to an embodiment of the present invention.

FIG. 2A and FIG. 2B are exemplary embodiments of disposing a touch sensing panel and a display device in two different hardware devices.

FIG. 3 is a flowchart of a control method for a touch control system according to an embodiment of the present invention.

### DETAILED DESCRIPTION OF THE INVENTION

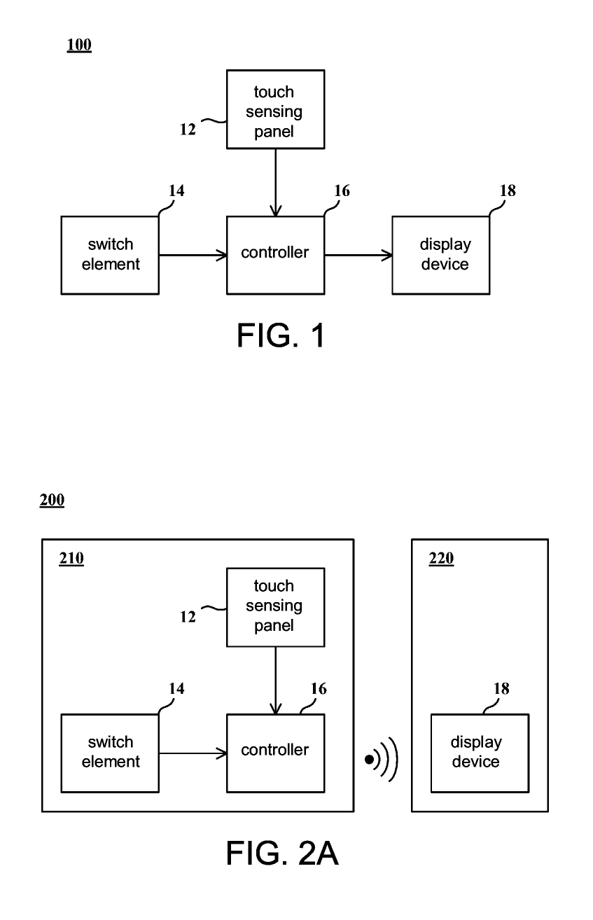

FIG. 1 shows a block diagram of a touch control system 100 according to an embodiment of the present invention. The touch control system 100 comprises a touch sensing panel 12, a switch element 14, a controller 16 and a display device 18. In practice, the touch control system 100 may be integrated into various electronic products (e.g., smart handsets, personal digital assistants, laptops, game consoles or portable pads) requiring touch functions, or may be an independent device. Further, the display device 18 may be disposed behind a transparent or semi-transparent touch sensing panel 12, and does not come into direct contact with a user.

In practice, the switch element 14 may be a mechanical key, a pressure-controlled virtual key, a photosensitive element or an image capturing device disposed outside the touch control system 10, but is not limited thereto. The switch element 14 has a first state and a second state. The type and state settings of the switch element 14 may be designed according to operation requirements and a product esthetical appearance of the touch control system 100.

Assuming that the switch element 14 is a mechanical key or a pressure-controlled virtual key, the controller 16 determines the state of the switch element 14 according to whether the key is pressed. For example, it may be defined that, the switch element 14 is in the first state when the key is pressed downwards to a predetermined level, or the switch element 14 is in the second state when the key is not pressed. Alternatively, it may be defined that, the switch element 14 is in the first state when being pressed or in the second state when not being pressed. The above pressure-controlled virtual key may be implemented through a predetermine region on the touch sensing panel 12, or may be provided outside the touch sensing panel 12.

Assuming that the switch element 14 is a photosensitive element, the state of the switch element 14 may be determined by an amount of light received by the photosensitive element. When a user finger presses on/above the photosensitive element, external light originally entering the photosensitive element may be shielded. Thus, the amount of light received by the photosensitive element may be a basis for the controller 16 to determine whether the switch element 14 is pressed by a user touch. For example, it may be defined that, the switch element 14 is in the first state when the amount of light received by the photosensitive element is smaller than a threshold, or else the switch element 14 is in the second state when the amount of light received by the photosensitive element is greater than the threshold. In practice, when the touch control system 100 is integrated into an electronic device with a built-in image capturing module, the switch element 14 may also be included in a photosensitive element of the image capturing module.

Assuming that the switch element 14 is an image capturing device, the state of the switch element 14 may be determined according to a captured image of the image capturing device. For example, the captured image is an almost-black image when a user finger presses against a lens of the image capturing device. Thus, the controller 16 may determine whether the switch element 14 is pressed by a user according to whether a captured image by the image capturing module is an almost-black image, and accordingly determine the state of the switch element 14.

In the following embodiment, to illustrate corresponding behaviors of the controller 16 when the switch element 14 is in the first state and the second state, it is assumed that the switch element 14 is a mechanical key, and the key is in the first state when being pressed or in the second state when not being pressed.

Apart from monitoring which state the switch element 14 is in, the controller 16 also monitors a user touch point on the touch sensing panel 12. The touch sensing panel 12 and the display device 18 may be configured to have a fixed relationship. In other words, when a user touches a certain touch point on the touch sensing panel 12, the controller 16 may translate the action as the user wishes to hit a corresponding image position in an image displayed on the display device 18 at the time when hitting the touch point.

Assuming that a user is playing games on the touch control system 100, and a user touch indicates a target point or a direction for firing virtual ammunition. When the switch element 14 is in the first state (i.e., when pressed), each time the touch control panel 12 is touched, the controller 16 generates position information corresponding to a touch point, and controls the display device 18 to provide the position information of the touch point to the user. For example, the controller 16 prompts the display device 18 to present an indication sign corresponding to the position of the touch point, e.g., a small finger image or a cross pattern, so as to allow the user to correctly learn that the touch point just entered corresponds to the position of the indication sign in the image displayed by the display device 18.

In this embodiment, the controller 16 is designed to record and prompt the display device 18 to consistently provide the position information corresponding to the touch point, and the position information corresponding to the touch point is only updated according to a new touch point when the touch sensing panel 12 is again touched. Therefore, even when the user disengages the finger from the touch sensing panel 12 or stops touching the touch sensing panel 12, the image position corresponding to a last touch point can still be observed. That is to say, according to the image position displayed by the display device 18, the user can clearly observe whether the position corresponding to the last touch occurs at an expected target position and thus fine tune the touch position if desired. It should be noted that, the procedure of firing virtual ammunition will not be performed by the controller 16 when the switch element 14 is still in the first state (i.e., when pressed). Therefore, before accurately touching the expected target position, the user is offered with the opportunity of re-selecting a touch point as long as the switch element 14 is pressed.

In the embodiment, once the switch element 14 is switched from the first state to the second state, the controller 16 performs a target procedure corresponding to a last point on the touch sensing panel 12, e.g., to prompt the display device 18 to display an animated picture of ammunition shooting towards the position and a result image of the position being bombed by the ammunition. In other words, the user may release the switch element 14 after confirming that the expected touch point is accurately touched, so as to allow the switch element 14 to enter from the first state to the second state to further trigger the procedure of firing virtual ammunition. As a result, the touch control system 100 is capable of eliminating an error of a user mistakenly pressing a non-target position to render a touch result satisfying a user's expectation. Further, as a target procedure is triggered by switching the state of the switch element 14 instead of by re-pressing the target position, a possible press error resulting from the user re-pressing the target position can thus be prevented.

In an embodiment, when the switch element 14 is in the second state (i.e., when not pressed), the controller 16 directly triggers the procedure of firing the virtual ammunition corresponding to a certain point whenever the user touches the point on the touch sensing panel 12. That is to say, the user may determine whether to keep the flexibility of re-selecting the touch point.

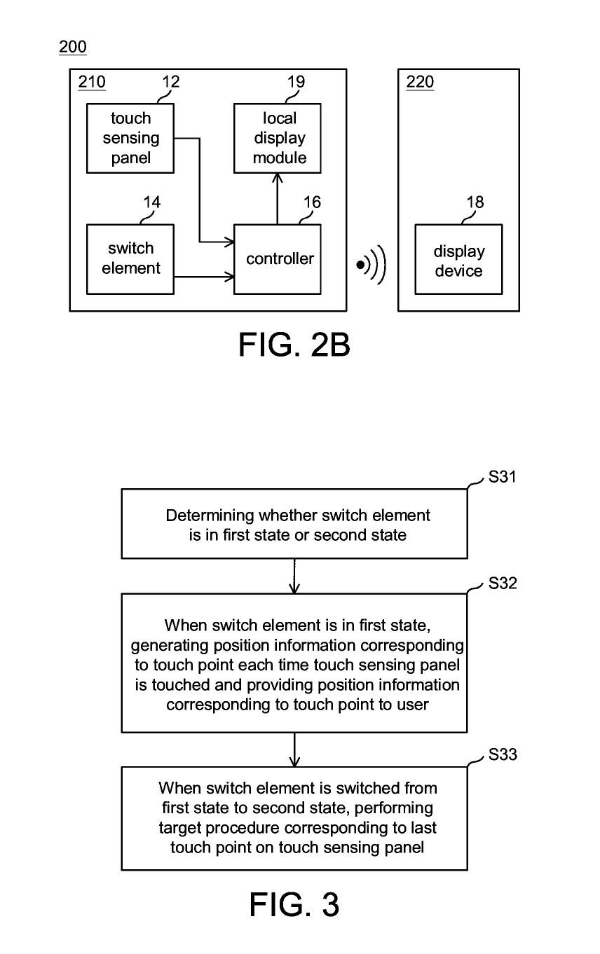

FIG. 2A shows a touch control system 200 according to another embodiment of the present invention. A main difference between the touch control system 200 and the touch control system 100 is that a touch sensing panel 12, a switch element 14 and a controller 16 of the touch control system 200 are disposed in a first hardware device 210, and a display device 18 is disposed in a second hardware device 220. The first hardware device 210 and the second hardware device 220 may be signally coupled to each other through wireless means. For example, the first hardware device 210 may be a smart handset, and the second hardware device 220 may be a television system. An advantage of the above design is that, the size of the display device 28 is not limited by the size of the first hardware device 210, and is thus capable of providing larger and clearer images. It should be noted that the controller 26 may also be disposed in the second hardware device 220.

As shown in FIG. 2B, the first hardware device 210 may also comprise a local display module 19. When the first hardware device 210 and the second hardware device 220 are signally coupled through wireless means, the controller 16 may control an image displayed by the local display device 19 to be turned off or to be the same as an image displayed by the display device 18. The power consumption of the touch control system 200 may be reduced by turning off the local display module 19.

The touch system in both FIGS. 2A and 2B are capable of assisting a user to achieve an optimized touch control result. In a situation where a touch sensing panel and a display device are separated, a user is less likely to accurately determine a corresponding relationship between a touch point and an image block, and such issue is solved by the touch control system of the present invention. For example, with an indication sign on a display device, a user is enabled to directly learn whether a touch just entered matches a target position, and to accordingly determine to which direction a next touch point on the touch sensing panel 22 is to be adjusted. That is to say, with the present invention applied in a separated touch sensing panel and a display device, accurate and intuitive controls for a user can be realized.

FIG. 3 shows a control method according to another embodiment of the present invention. The control method is applied to a touch control system comprising a touch sensing panel and a switch element. As previously described, there are various combinations of the types and states of the switch element. In step S31, it is determined whether the switch element is in a first state or in a second state. It should be noted that, step S31 is persistently performed, and is not suspended due to the proceeding of the subsequent process. In step S32, when the switch element is in the first state, position information corresponding to a touch point is generated each time the touch sensing panel is touched, and the position information of the touch point is provided to a user. In step S33, once the switch element is switched from the first state to the second state, a target procedure corresponding to a last touch point on the touch sensing panel is performed. In the control method, when the switch element is in the first state, the target procedure is not performed. Variations in descriptions associated with the touch control systems 100 and 200 are applicable to the control method in FIG. 3, and shall be omitted herein.

Therefore, with the touch control system and the control method of the above embodiments, before a user touches an intended target position, a user is given an option of re-selecting a touch point through manipulating a switch element. In other words, with the touch control system and the control method thereof, a user is offered greater flexibility so that a corresponding subsequent procedure is only allowed to take place after accurately hitting an intended target position.

It is noted that the several components described herein, including but not limited to the controller 16, may be embodied in hardware, software or a combination thereof. In one possible implementation controller 16 may be embodied in an application specific integrated circuit (ASIC) including memory, a processor and input/output interconnected in such a way so as to enable connectivity, as appropriate, with switch element 14, touch sensing panel 12, and display device 18, etc.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch control system, comprising:
a touch sensing panel;
a display device;
a switch element, configured to switch in a first state and a second state; and
a controller, when the switch element is in the first state, and a touch point is generated and updated each time the touch control panel is touched, generating position information corresponding to the touch point and controlling the display device to provide the position information corresponding to the touch point;
wherein, when the switch element is switched from the first state to the second state, the controller performs a target procedure corresponding to the touch point.

2. The touch control system according to claim 1, wherein when the switch element is in the second state, and the touch point is generated each time the touch control panel is touched, the controller performs the target procedure corresponding to the touch point.

3. The touch control system according to claim 1, wherein when the switch element is in the first state, and the touch point is updated each time the touch control panel is touched, the controllers prompts the display device to continually provide the position information corresponding to the touch point.

4. The touch control system according to claim 1, wherein the switch element is a mechanical key or a pressure-controlled key, and the controller determines whether the switch element is in the first state or the second state according to whether the switch element is pressed.

5. The touch control system according to claim 1, wherein the switch element is a photosensitive element, and the controller determines whether the switch element is in the first state or the second state according to an amount of light received by the switch element.

6. The touch control system according to claim 1, wherein the switch element is an image capturing device, and the controller determines whether the switch element is in the first state or the second state according to an captured image of the switch element.

7. The touch control system according to claim 1, wherein the controller prompts the display device to display an indication sign to provide the position information corresponding to the touch point.

8. The touch control system according to claim 7, wherein the touch control panel and the switch element are disposed in a first hardware device, the display device is disposed in a second hardware device, and the first hardware device and the second hardware device are signally coupled through wireless means.

9. The touch control system according to claim 8, wherein the second hardware device is a television system.

10. The touch control system according to claim 8, wherein the first hardware device comprises a local display module; when the first hardware device and the second hardware device are signally coupled through wireless means, a first image displayed by the local display module is turned off or is identical to a second image displayed by the display device.

11. A control method, for a touch control system comprising a touch control panel and a switch element, the switch element having a first state and a second state; the control method comprising:
a) determining whether the switch element is in the first state or the second state:
b) when the switch element is in the first state, and a touch point is generated and updated each time the touch control panel is touched, generating position information corresponding to the touch point and providing the position information corresponding to the touch point; and
c) when the switch element is switched to the second state, performing a target procedure corresponding to the touch point.

12. The control method according to claim 11, further comprising:
when the switch element is in the second state, and the touch point is generated each time the touch control panel is touched, performing the target procedure corresponding to the touch point.

13. The control method according to claim 11, wherein step (b) further comprises continually providing the position information corresponding to the touch point.

14. The control method according to claim 11, wherein the switch element is a mechanical key or a pressure-controlled key, and step (a) comprises determining whether the switch element is in the first state or the second state according to the whether the switch element is pressed.

15. The control method according to claim 11, wherein the switch element is a photosensitive element, and step (a) comprises determining whether the switch element is in the first state or the second state according to an amount of light received by the switch element.

16. The control method according to claim 11, wherein the switch element is an image capturing device, and step (a) comprises determining whether the switch element is in the first state or the second state according to an captured image of the switch element.

17. The control method according to claim 11, wherein the touch control system further comprises a display device; in step (b), the position information corresponding to the touch point is presented as an indication sign on the display device.

18. The control method according to claim 17, wherein the touch control panel and the switch element are disposed in a first hardware device, the display device is disposed in a second hardware device, and the first hardware device and the second hardware device are signally coupled through wireless means.

19. The control method according to claim 18, wherein the second hardware device is a television system.

20. The control method according to claim 18, wherein the first hardware device comprises a local display module; the control method further comprising:
when the first hardware device and the second hardware device are signally coupled through wireless means, controlling a first image displayed by the local display module to be turned off or to be identical to a second image displayed by the display device.
